(19) United States
(12) Patent Application Publication
(10) Pub. No.: US 2008/0287020 A1
(43) Pub. Date: Nov. 20, 2008

(54) METHOD AND COMPOSITION FOR TREATING FIBROUS SUBSTRATES

(76) Inventor: Martin A. Rudat, Woodstock, GA (US)

Correspondence Address: INVISTA NORTH AMERICA S.A.R.L., THREE LITTLE FALLS CENTRE/1052, 2801 CENTERVILLE ROAD, WILMINGTON, DE, 19808, US

(21) Appl. No.: 12/122,876

(22) Filed: May 19, 2008

Related U.S. Application Data
(60) Provisional application No. 60/938,742, filed on May 18, 2007.

(51) Int. Cl. B32B 27/04; C11D 3/37; D06M 15/256

(52) U.S. Cl. 442/94; 510/528; 8/115.6

(57) ABSTRACT

Embodiments of the present disclosure include soil repellent compositions, methods for imparting resistance to soiling on a fibrous substrate, fibrous substrates to which a soil repellent composition has been applied and dried, methods of making soil repellent compositions, and the like.

### CROSS-REFERENCE TO RELATED APPLICATION

This application claims priority to U.S. provisional application entitled, “METHOD AND COMPOSITION FOR TREATING FIBROUS SUBSTRATES,” having Ser. No. 60/938,742, filed on May 18, 2007, which is entirely incorporated herein by reference.

### FIELD OF INVENTION(S)

The present disclosure relates soil repellent compositions for treating fibrous substrates, methods of making, and the like.

### BACKGROUND

Stain and soil repellent chemicals are often applied during the production of fibrous substrates including carpets and textile products used for upholstery, bedding, and other textiles. Anti-soil treatments of such fibrous substrates have primarily been based on variations of highly fluorinated polymers which, among other effects, tend to reduce the surface energy of the fibers resulting in a decrease in the soiling of the fibrous substrates. A considerable disadvantage of such fluorinated polymers is their high cost.

Non-fluorinated polymers have also been developed to treat fibrous substrates, especially carpets, to reduce soiling. Examples include silicones, silicates, and certain silsesquioxanes. However, these non-fluorinated compositions generally do not provide the same soil repellent effect on fibrous substrates compared to the fluorinated polymers.

Recently, combinations of fluorinated polymers with non-fluorinated materials have been shown to be useful to treat nylon carpets. In certain cases, even though the carpets have shown certain soil resistance, the feel of some of these treated carpets to the hand, or “hand,” (or “handle”) is less pleasant than the original, untreated carpets, especially when they have also been treated with stain-resistant compositions. Without being limited by theory, this condition is believed to be related to the lack of a certain type of lubricity of the textile substrate fibers at the surface of the soil and stain resist layers on the fiber, possibly resulting in a rough feeling and an apparent differential between static and dynamic friction between fibers as they interact with other surfaces and each other.

A satisfactory handle, including smooth interactions between carpet fibers, is especially important for fibrous substrates such as carpets and textile products used for upholstery, bedding, and other interior applications. Increased value-in-use is associated with a luxurious tactile sensation that is preferred and desirable for these fibrous substrates. However, attempts to improve handle by the addition of non-fluoropolymer topically-applied agents have been problematic because such agents tend to cause increased soiling and they generally wear or wash off quickly, rapidly losing their tactile effectiveness.

A new low cost composition is needed for treating fibrous substrates not only having the soil repellent effect but also maintaining a smooth and high-quality handle.

### SUMMARY

Embodiments of the present disclosure include soil repellent compositions, methods for imparting resistance to soiling on a fibrous substrate, fibrous substrates to which a soil repellent composition has been applied and dried, methods of making soil repellent compositions, and the like. One exemplary soil repellent composition imparting soil resistance on a fibrous substrate, among others, includes: a water-based mixture of: a fluorochemical, a silsesquioxane-containing sol, and a lubricity-enhancing agent.

One exemplary method for imparting resistance to soiling on a fibrous substrate, among others, includes: contacting the fibrous substrate with a soil repellent composition followed by drying, the soil repellent composition comprising a water-based mixture of: a fluorochemical, a silsesquioxane-containing sol, and a lubricity-enhancing agent.

One exemplary fibrous substrate, among others, includes: a fibrous substrate to which a soil repellent composition has been applied and dried, where the soil repellent composition includes a water-based mixture of: a fluorochemical, a silsesquioxane-containing sol, and a lubricity-enhancing agent.

One exemplary method for imparting resistance to soiling on a fibrous substrate, among others, includes: (a) mixing a fluorochemical and a silsesquioxane-containing sol to form a blend; (b) treating the fibrous substrate with the blend; (c) applying a lubricity-enhancing agent to the treated fibrous substrate; and (d) drying.

One exemplary method for imparting resistance to soiling on a fibrous substrate, among others, includes: (a) mixing a fluorochemical and a lubricity-enhancing agent to form a blend; (b) treating the fibrous substrate with the blend; (c) applying a silsesquioxane-containing sol to the treated fibrous substrate; and (d) drying.

One exemplary method for imparting resistance to soiling on a fibrous substrate, among others, includes: (a) treating the fibrous substrate with a fluorochemical, (b) mixing a silsesquioxane-containing sol and a lubricity-enhancing agent to form a blend; (c) applying the blend to said fibrous substrate from step (a); and (d) drying.

One exemplary method for imparting resistance to soiling on a fibrous substrate, among others, includes: (a) contacting the fibrous substrate with a fluorochemical; (b) treating the fibrous substrate from step (a) with a silsesquioxane-containing sol; (c) applying a lubricity-enhancing agent to the fibrous substrate from step (b); and (d) drying.

These embodiments, uses of these embodiments, and other uses, features and advantages of the present disclosure, will become more apparent to those of ordinary skill in the relevant art when the following detailed description of the preferred embodiments is read in conjunction with the appended figures.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of synthetic organic chemistry, fabrics, textiles, and the like, which are within the skill of the art.

The following examples are put forth so as to provide those of ordinary skill in the art with a complete disclosure and description of how to perform the methods and use the probes disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a compound” includes a plurality of compounds. In this specification and in the claims that follow, reference will be made to a number of terms that shall be defined to have the following meanings unless a contrary intention is apparent.

### DEFINITIONS

As used herein, the term “fiber” refers to filamentous material that can be used in fabric and yarn as well as textile fabrication. One or more fibers can be used to produce a fabric or yarn. The yarn can be fully drawn or textured according to methods known in the art.

As used herein, the term “fibrous substrate” includes, but is not limited to, textiles, carpets, apparel, furniture coverings, drapes, upholstery, bedding, automotive seat covers, and the like, that include fibers or yarns.

As used herein, the term “carpet” may refer to a structure including a primary backing having a yarn tufted through the primary backing. The underside of the primary backing can include one or more layers of material (e.g., coating layer, a secondary backing, and the like) to cover the backstitches of the yarn.

As used herein, the term “primary backing” and/or the “secondary backing layer” may refer to woven or non-woven materials. The woven materials may be natural materials or synthetic materials. The woven materials can include, but are not limited to, cotton, rayon, jute, wool, polyolefins (e.g., polypropylene and polyethylene), polyester, and/or polyamide. The non-woven materials can include fibers such as, but not limited to, polypropylene, rayon, polyethylene, polyester, polyamide, and combinations thereof, blends thereof, and the like.

As used herein, the term “backing” refers to the primary backing, secondary backing, coating layer, combinations thereof, and the like.

The term “lubricity” refers to the capacity for reducing friction or the ability to lubricate (e.g., make more slippery or smoother).

The term “sol” refers to a colloid that has a continuous liquid phase in which a solid is suspended in a liquid.

### General Discussion

Embodiments of the present disclosure include soil repellent compositions, methods for imparting resistance to soiling on a fibrous substrate, fibrous substrates to which a soil repellent composition has been applied and dried, methods of making soil repellent compositions, and the like.

Embodiments of the present disclosure include soil repellent compositions that include at least two of or all three of: a fluorochemical, a silsesquioxane-containing sol, and a lubricity-enhancing agent. Embodiments of the soil repellent composition can be used to impart soil resistance to a fibrous substrate. In addition, embodiments of the present disclosure include fibrous substrates to which a soil repellent composition has been applied and/or dried.

Embodiments of the present disclosure include methods for imparting resistance to soiling on a fibrous substrate. In an embodiment, the method includes contacting the fibrous substrate with a soil repellent composition followed by drying.

Embodiments of the present disclosure include methods for imparting resistance to soiling on a fibrous substrate. In an embodiment, the method includes the steps of: mixing a fluorochemical and a silsesquioxane-containing sol to form a blend; treating the fibrous substrate with the blend; applying a lubricity-enhancing agent to the treated fibrous substrate; and drying. In an embodiment, the steps are performed sequentially.

In another embodiment, the method includes the steps of: mixing a fluorochemical and a lubricity-enhancing agent to form a blend; treating the fibrous substrate with the blend; applying a silsesquioxane-containing sol to the treated fibrous substrate; and drying. In an embodiment, the steps are performed sequentially.

In another embodiment, the method includes the steps of: (a) treating the fibrous substrate with a fluorochemical; (b) mixing a silsesquioxane-containing sol and a lubricity-enhancing agent to form a blend; (c) applying the blend to the fibrous substrate from step (a); and (d) drying. In an embodiment, the steps are performed sequentially.

In another embodiment, the method includes the steps of: a) contacting the fibrous substrate with a fluorochemical; (b) treating the fibrous substrate from step (a) with a silsesquioxane-containing sol; (c) applying a lubricity-enhancing agent to the fibrous substrate from step (b); and (d) drying. In an embodiment, the steps are performed sequentially.

### Discussion

Certain anti-soil compositions, including fluorochemicals with silsesquioxane sols, can adversely affect the hand of various textiles, especially when other chemistries, such as stain resists are also applied. It has been found that a small amount of a suitable lubricity-enhancing agent, when co-applied with an anti-soil treatment composition specifically including a fluorinated polymer and a silsesquioxane-containing sol can restore the smooth feel and overall handle of fibrous substrates without compromising the soil resistance imparted by the overall composition. Surprisingly small quantities of lubricity-enhancing agent provide the greatest benefit when compared to the application rates typical for similar materials. Even more surprisingly, when applied to carpet, the durability of the improved hand imparted by the minor lubricity-enhancing component is similar to that of the other substrates throughout the wear life of the carpet.

A surprising aspect of the present disclosure can be expressed in terms of other processes which are known to affect textile hand. For those textile treatment processes in which the same or similar agents are used to improve handle, a large quantity of the agent is usually applied to create the desired hand. For example, 2% to 10% on weight of fiber (owf) or on weight of goods (owg), or more, of such agents (including the water in which they are generally received) is typically applied, as recommended by the manufacturers of the respective agents.

In the same method of measure, embodiments of the present disclosure include the application of about 0.01% up to less than about 1.0% owf of a lubricity-enhancing agent by weight of the solution/dispersion/emulsion including water. Furthermore, when used as a lubricity-enhancing agent in the compositions of the present disclosure, it has been found that the effects imparted are resistant to wear and cleaning even at such low levels, unlike the expected rapid loss of such small applied quantities, an effect which is overcome in conventional uses because of the high level of application.

In one embodiment, about 0.05% to 0.5% owf of the lubricity-enhancing agent plus water carrier can be used. In yet another embodiment, about 0.15% to 0.4% owf of the lubricity-enhancing agent in water can be used effectively on fibrous substrates that have been simultaneously treated with the soil repellent composition of the present disclosure to restore smooth feeling and handle and to maintain this effect through multiple washings and extended wear. Expressed as solids content on fiber, excluding added water, these amounts represent ranges of about 0.015% to 0.2% owf, and about 0.05% to 0.15% owf, respectively.

Surprisingly, the use of the lubricity-enhancing agent at such levels as part of the present disclosure does not cause embodiments of the carpet or textile to exhibit an increase in soiling tendency vs. a similar composition without lubricity-enhancing agent, even when the lubricity-enhancing agent itself would be expected to cause increased soiling. It is unexpected and surprising that embodiments of the present disclosure have the capability to balance handle-improvement properties with anti-soil performance, and simultaneously provide both properties as a durable treatment.

The lubricity-enhancing agents suitable for embodiments of the present disclosure can be selected from materials that are solution-compatible with the anti-soil compositions, especially in the aspect of the nature of the dispersion/emulsion (e.g., cationic, non-ionic, amphoteric, or anionic). Otherwise, metal ions such as magnesium, which may be present in embodiments of the lubricity-enhancing agents, may interact chemically with the anti-soil compositions and precipitate in the dispersion or otherwise disrupt the stability of the composition. In the absence of other negative interactions, normally the cationic agents can be mixed with cationic or non-ionic anti-soil materials; anionic agents can be successfully mixed with anionic or non-ionic anti-soil materials; and non-ionic agents can be successfully mixed with anionic, cationic, or non-ionic anti-soil materials. Despite these generalities, other aspects of the compositions and the various surfactants and other ingredients used may impact the suitability and stability of a particular mixture; such considerations are well-known to those who practice such formulation art.

A variety of types of lubricity-enhancing agents may be suitable for the specific combinations of process requirements and material-compatibility requirements in various embodiments of the present disclosure. The textile lubricity-enhancing agents can include, but are not limited to, aminosilicones, silicones, oils of various types, polyalkylene glycols, polyalkylene waxes, partially-oxidized polyalkylene waxes, lanolin and lanolin derivatives, fatty acids, fatty acid esters, oxidized or functionalized polyolefins, and stearates.

In another embodiment, a lubricity-enhancing agent can be based on high density and/or high molecular weight polyolefin micro- and nanoparticles dispersed in a neutral pH, non-ionic water system. A stable dispersion or a stabilized emulsion of such materials can be achieved by using appropriate surfactants. An example includes, but is not limited to, an emulsion of high density polyethylene wax that may be partially oxidized to aid in forming a stable emulsion; many suppliers of textile treatment chemicals offer versions of such products, primarily as sewing and cutting aids. An example of a commercial product that is effective in the present disclosure is the Fluftone® HDW series, made by Apollo Chemicals, Graham, N.C., which is described as being a non-ionic, neutral pH emulsion of high density polyethylene wax, which may be partially oxidized.

In another embodiment employing dispersed solids, the lubricity-enhancing agent can be derived from a high density polyethylene that is oxidized to lesser or greater extent than about 35-40%, and used with suitable surfactants of a type compatible with the other components of the present disclosure as previously described.

In conventional uses, lubricating agents are generally applied in a bath (exhaust) or padding treatment at application rates of about 2% to 10% or more owf or owg by weight of the supplied solutions, emulsions, or dispersions (corresponding to about 0.5% to more than 2% solids owf or owg). Under such conditions, the applied agent dominates the tactile handle of the fibrous substrates, and also dominates the surface properties of the substrates. This provides a textile with a certain handle until the agent is worn or washed off. Furthermore, such conditions may result in increased soiling and/or staining effects on the textile substrate.

In contrast, the process of the present disclosure only need very small quantities of the lubricity-enhancing agents to be applied in order to restore the original fabric handle without adversely affecting other surface properties (e.g., soiling or staining), while maintaining handle throughout the wear and periodic cleaning of the article. In an embodiment, application of about 0.01% to less than 1.0% or about 0.1% to 0.5%, owf or owg (corresponding to about 0.03% to less than about 0.35% solids owf or owg) of suitable lubricity-enhancing agents has been found to be surprisingly effective in accomplishing this goal.

The fluorochemical compounds used in the embodiments of the present disclosure can be water insoluble and have one or more fluoro-aliphatic radicals, typically one or more perfluoroalkyl radicals. The number of perfluoroalkyl radicals can be in the range of from about 3 to 18. There are essentially no restrictions of which the applicant is aware to the type of fluorochemical compound with which the present disclosure can be used effectively in combination with silsesquioxane chemistry, as long as a compatible combination of surfactant types and/or other ingredients is identifiable, as described above.

In one embodiment of the present disclosure, fluorocarbonylimino biuret can be used as taught in U.S. Pat. No. 4,958,039, the disclosure of which is incorporated herein by reference for the corresponding discussion. As an example, mention is made of the reaction product of two moles of a mixture of fluoroalcohols of the formula F(CF₂CF₂)ₙCH₂CH₂OH, where n is predominately 5, 4, and 3, with one mole of 1,3,5-tris(6-iso-cyanotohexyl)biuret followed by reaction of residual isocyanate groups with a modifier such as 3-chloro-1,2-propanediol.

In another embodiment of the present disclosure, fluoroesters can be used as taught in U.S. Pat. No. 3,923,715 and U.S. Pat. No. 4,029,585, the disclosures of which are incorporated herein by reference for the corresponding discussion. These patents disclose perfluoroalkyl esters of carboxylic acids of 3 to 30 carbon atoms.

In another embodiment, fluoroester urethane compounds can be used in the embodiments of the present disclosure. Such compounds are described in the aforementioned U.S. Pat. No. 4,029,585. Citric acid urethane can be used in embodiments of the present disclosure and may be obtained by reacting the citric acid ester mentioned above with 1-methyl-2,4-diisocyanatobenzene.

In another embodiment, fluoropolymer can be used in the present disclosure with a fluoropolymer composition as taught in U.S. Pat. No. 3,645,990 (Raynolds), the disclosure of which is incorporated herein by reference for the corresponding discussion. The patents describe, respectively, fluorinated polymers from acrylic and methylacrylic derived monomers having the structures

CH₂═CH—CO₂CH₂CH₂R_{f}

and

CH₂═C(CH₃)—CO₂CH₂CH₂R_{f}

where R_{f} is a perfluoroalkyl group of about 4 through 14 carbons, and methyl acrylate or ethyl acrylate, optionally with small amounts of other monomers. An example of such a fluoropolymer is the copolymer of the last mentioned formula, wherein R_{f} is a mixture of perfluoroaliphatic radicals of 8 to 16 carbons, with methylacrylate in a 74:26 weight ratio.

Commercially available fluorochemical compounds may be used in embodiments of the present disclosure. These compounds include, but are not limited to, Zonyl® 8070, Zonyl® 8779, Zonyl® 9997, N-140, N-145, and NRD-626 available from E. I. DuPont de Nemours, Wilmington, Del.; Unidyne® TG-3610, available from Daikin America, Inc., Cohutta, Ga.; and Scotchgard™ FC255, and Scotchgard™ FC214-230, available from 3M, St. Paul, Minn. Suitable commercially-available products include so-called C8, C6, and C4 fluorochemicals from various manufacturers.

Silsesquioxane-containing sols of the present disclosure can include, but are not limited to, discrete particles of repeating formula SiO₂ within a size range from about 1 to 100 nm diameter that are surface modified with polymers of formula RSiO_{3/2}, where R is hydrocarbons or substituted hydrocarbons of up to 7 carbon atoms, which are in a medium such as water or the like. In another embodiment, the silsesquioxane-containing sol includes discrete particles comprising SiO₂ repeat units that are surface modified with siloxane moieties that can include, but are not limited to, copolymers of unit formula RSiO_{3/2}, R′₂SiO and/or R″₃SiO_{1/2} where R′ and R″ are hydrocarbons or substituted hydrocarbons of up to 7 carbon atoms, which are in a medium such as water or the like. Any of these siloxane repeat units can be used in combination or independently as a siloxane coating on such described discrete particles of formula SiO₂. In an embodiment, the discrete silsesquioxane-containing sol products described in U.S. Pat. No. 6,225,403, which is incorporated herein by reference for the corresponding discussion, can also be used.

Stain resistant agents can also be added to treat the fibrous substrates along with embodiments of the present disclosure. Such stain resistant agents (so-called stain blockers) may be applied in a separate step prior to application of the other components of the present disclosure, or co-applied with one or more of those components. The stain resistant agents applied in the present disclosure include, but are not limited to, at least one of the water-soluble or water-dispersible polymeric sulfonated phenol-formaldehyde condensation products, mixtures containing any of hydrolyzed maleic anhydride/α-olefin copolymers, hydrolyzed maleic anhydride/styrene copolymers, polymethacrylic acid polymers, polymethacrylic acid copolymers, or mixtures of the above compositions, wherein the mixtures may include additional active ingredients to improve stain resistance, oxidation resistance, fade resistance, and the like.

The polymeric sulfonated phenol-formaldehyde condensation products can be any of those described in the prior art as being useful as dye-resist agents or dye-fixing agents. Particular examples include, but are not limited to, diphenolic sulfones, and sulfonated naphthalene condensates. A particular sulfonated phenol-formaldehyde suitable used in present disclosure contains a condensation product of 4,4′-dihydroxy diphenylsulfone, and formaldehyde. Other sulfonated phenol-formaldehyde condensation products that may be used in the present disclosure include those disclosed in U.S. Pat. Nos. 5,501,591; 5,592,940; 4,680,212; 4,822,373; 4,937,123; 5,447,755; 5,654,068; 5,708,087; 5,707,708; 5,074,883; 4,940,757; 5,061,763; and 5,629,376, which are all incorporated herein by references for the corresponding discussion.

Commercial condensation products without sulphonic acid and carboxyl groups can be obtained for example under the name ZELAN® 8236 from DuPont, Wilmington, Del., USA. ZELAN® 8236 is a base catalyzed condensation product of 4,4′bis(hydroxyphenyl) sulfone and formaldehyde. Condensation products with sulphonic acid groups are commercially obtainable for example from Zschimmer & Schwarz Mohsdorf GmbH & Co., Mohsdorf, Germany under the name Zetesal NT and from CHT R. Beitlich GmbH, Tubinen, Germany under the name Rewin KBL or Rewin KF as well as Tubicoat KF.

A variety of linear and branched chain alpha-olefins (α-olefin) can be used to form a copolymer with maleic anhydride. Particularly useful alpha-olefins are 1-alkenes, containing 4 to 12 carbon atoms, preferably C₄₋₁₀, such as isobutylene, 1-butene, 1-hexene, 1-octene, 1-decene, and dodecene. Hydrolyzed maleic anhydride/styrene copolymers can also be used in the present disclosure.

A part of the maleic anhydride in the copolymer can be replaced by acrylic acid, methacrylic acid, itaconic acid, vinyl sulfonic acid, vinyl phosphonic acid, styrene sulfonic acid, alkyl(C₁₋₄) acrylate, alkyl(C₁₋₄) methacrylate, vinyl acetate, vinyl chloride, vinylidine chloride, vinyl sulfides, N-vinyl pyrrolidone, acrylonitrile, acrylamide, and mixtures thereof. In another embodiment, a part of the maleic anhydride can be replaced by maleimide, N-alkyl (C₁₋₄₋) maleimides, N-phenylmaleimide, fumaric acid, crotonic acid, cinnamic acid, alkyl (C₁₋₁₈) esters of the foregoing acids, cycloalkyl (C₃₋₈) esters of the foregoing acids, sulfated castor oil, or the like.

The maleic anhydride copolymers useful in the present disclosure can be prepared according to the methods well-known in the art. The maleic anhydride polymers thus obtained can be hydrolyzed to free acids or their salts by reaction with water or alkali, or they can also be reacted with C₁₋₄ alkyl alcohol to provide polymeric alpha-olefin/maleic acid monoesters. Generally, the hydrolyzed maleic anhydride polymer, or the monoester polymer, should be sufficiently water-soluble that a uniform application to a fibrous surface can be achieved at an appropriate acidity. However, applications using water dispersions of the polymer mixed with a suitable surfactant may be used to impart stain-resistance.

Preparation of Maleic Anhydride/Alpha-Olefin Polymers is Also described in Reissue U.S. Pat. No. 28,475 and in EP 306992 the disclosures of which are specifically incorporated by reference for the corresponding discussion. These references contain further teaching of techniques for the preparation of such polymers.

In an embodiment, the methacrylic polymer includes the polymethacrylic acid homopolymer as well as polymers formed from methacrylic acid and one or more other monomers. The monomers useful for copolymerization with the methacrylic acid are monomers having ethylenic unsaturation. Such monomers include, for example, monocarboxylic acids, polycarboxylic acids, and anhydrides; substituted and unsubstituted esters and amides of carboxylic acids and anhydrides; nitriles; vinyl monomers; vinylidene monomers; mono-olefinic and polyolefinic monomers; and heterocyclic monomers.

Representatives of the specific monomers include, but are not limited to, acrylic acid, itaconic acid, citraconic acid, aconitic acid, maleic acid, maleic anhydride, fumaric acid, crotonic acid, cinnamic acid, oleic acid, palmitic acid, vinyl sulfonic acid, vinyl phosphonic acid, alkyl or cycloalkyl esters of the foregoing acids, alkyl or cycloalkyl having 1 to 18 carbon atoms such as, for example, ethyl, butyl, 2-ethylhexyl, octadecyl, 2-sulfoethyl, acetoxyethyl, cyanoethyl, hydroxyethyl and hydroxypropyl acrylates and methacrylates, and amides of the foregoing acids, such as, for example, acrylamide, methyacrylamide, and 1,1-dimethylsulfoethylacrylamide, acrylonitrile, methacrylonitrile, styrene, α-methylstyrene, p-hydroxystyrene, chlorostyrene, sulfostyrene, vinyl alcohol, N-vinyl pyrrolidone, vinyl acetate, vinyl chloride, vinyl ethers, vinyl sulfides, vinyl toluene, butadiene, isoprene, chloroprene, ethylene, isobutylene, vinylidene chloride, sulfated castor oil, sulfated sperm oil, sulfated soybean oil, and sulfonated dehydrated castor oil. In an embodiment, the monomers include, for example, alkyl acrylates having 1-4 carbon atoms, itaconic acid, sodium sulfostyrene, and sulfated castor oil. The mixtures of the monomers, such as, for example, sodium sulfostyrene and styrene, and sulfated castor oil and acrylic acid, can be copolymerized with the methacrylic acid.

In an embodiment, the methacrylic polymers of the present disclosure relates to those prepared by polymerizing methacrylic acid, with or without at least one other ethylenically unsaturated monomer described above, in the presence of sulfonated hydroxy-aromatic compound/formaldehyde condensation resins. Those homopolymers and copolymers and their preparation are described in the U.S. Pat. No. 4,940,757 (Moss), the contents of which are incorporated herein by reference for the corresponding discussion.

In the production of an embodiment of the present disclosure, a fluorochemical, a silsesquioxane-containing sol, and a lubricity-enhancing agent can be blended together to form a mixture, which may also contain additional water. The mixing may be conducted as a part of the make-up of a concentrate that will be further diluted prior to the application to the fibrous substrates. In another embodiment, the mixing can be conducted as a part of the make-up of a solution to be applied to the substrates without further concentration or composition adjustment in an on-line mixing/injection system that controls the ratio of the solutions being mixed, or any other means of mixing the materials prior to application to the substrates.

In another embodiment, a fluorochemical and a silsesquioxane-containing sol can be mixed together. The mixture is then used to treat fibrous substrates. In one embodiment, the fluorochemical may contain a fluoropolymer having perfluoroalkyl radicals of 3 to 6 carbons. After the treatment, the fibrous substrates can be further treated with a lubricity-enhancing agent.

In another embodiment, fibrous substrates are initially treated with a fluorochemical. Then the fibrous substrates can be further treated with a mixture of a silsesquioxane-containing sol and a lubricity-enhancing agent.

In another embodiment, fibrous substrates can be separately treated with a fluorochemical, a silsesquioxane-containing sol solution, and a lubricity-enhancing agent.

In an embodiment, application to the fibrous substrates can be accomplished by any known techniques in the treatment of fibrous substrates including spray, pad, or exhaust application methods, and co-application with other treatments. Such co-application may include, but is not limited to, stain resist (also called stain blocker) application to carpets and other textiles. Generally, co-application for carpets also requires a pH adjustment to a strongly acidic condition, such as pH=2 or 3, and sometimes lower. Other additives such as salts, antioxidants, or stabilizers are often included in the treatment. For such co-application conditions, the lubricity-enhancing additive must also be stable to strong acids and the additional process conditions required for such treatments, such as steam exposure.

The fibrous substrates can also be treated with a blend of a fluorochemical and a silsesquioxane-containing sol. The content of each ingredient can be varied depending on the requirement of the treatment.

In an embodiment, a final step in one or more of the treatments noted above, as is practiced commercially in the production of conventional carpets and other textiles, is the drying under heat of the fibrous substrate. Typically, the fluorochemical materials that are often used in these treatments require that the fibrous substrate be exposed to elevated temperatures specified by the manufacturer for time periods specified by the manufacturer to ensure adequate spreading, curing, or other phenomena associated with the finishing of the fluorochemical. Such conditions continue to apply and are utilized with the present disclosure, and thus vary with the particular fluorochemical product used therein.

Extensions of the present disclosure can incorporate other additives for their specific purposes, such as UV screeners or fluorochemical “extenders,” are contemplated, and these may be incorporated into the embodiments of the present disclosure as described, including the methods in which the components are separated into multiple application steps or when used in combination with stain resist treatment in co-application. Likewise, inclusion of other compatible additives or required components, such as organic or inorganic acids, antioxidants, or polymer “extenders,” with the stain resist in co-application is contemplated herein.

An embodiment of the soil repellent composition includes about 1 to 99 wt percent of the fluorochemical (typically 15 to 30% solids) or about 10 to 50 wt percent of the fluorochemical. An embodiment of soil repellent composition includes about 1 to 99 wt percent of the silsesquioxane-containing sol (typically 20 to 30% solids) or about 20 to 50 wt percent of the silsesquioxane-containing sol. An embodiment of soil repellent composition includes about 0.01 to 2 wt percent (typically 25% to 40% solids), about 0.1 to 1.5 wt percent, about 0.5 to 1.5 wt percent, about 0.1 to 1.3 wt percent, about 0.1 to 1.2 wt percent, about 0.5 to 1.2 wt percent, about 0.9 to 1.0 wt percent, or about 0.01 to 0.2 wt percent, of the lubricity-enhancing agent. An embodiment can include one or more combinations of the amounts noted above of two or three of: the fluorochemical, the silsesquioxane-containing sol, and lubricity-enhancing agent. The remaining portion of each of the compositions is water or other medium. In an embodiment, the total solids applied to the fibrous substrate product by weight is about 0.01 to 5%, about 0.1 to 5%, 0.01 to 1%, 0.1 to 1%, 0.02 to 0.5%, 0.05 to 0.35, or 0.01 to 0.2%, based on the total weight of the fibrous substrate.

### Test Methods

Soiling: An accepted laboratory carpet soiling test method is ASTM D6540. Within the reproducibility limitations of this test, the relative soiling performance of variously-treated samples may be determined. The test simulates the soiling of carpet in residential or commercial environments to a traffic count level of about 100,000 to 300,000.

According to ASTM D6540, soiling tests can be conducted on up to six carpet samples simultaneously using a drum. The base color of the sample (using the L, a, b color space) was measured using the hand held color measurement instrument sold by Minolta Corporation as “Chromameter” model CR-310. This measurement was the control value. The carpet sample was mounted on a thin plastic sheet and placed in the drum. Two hundred fifty grams (250 g) of dirty Zytel 101 nylon beads (by DuPont Canada, Mississauga, Ontario) were placed on the sample. The dirty beads were prepared by mixing ten grams (3 g) of AATCC TM-122 synthetic carpet soil (by Manufacturer Textile Innovators Corp. Windsor, N.C.) with one thousand grams (1000 g) of new Nylon 101 Zytel beads. One thousand grams (1000 g) of ⅜-inch diameter steel ball bearings were added into the drum. The drum was run for 30 minutes with direction reversal every five minutes and the sample removed.

The sample was vacuumed four (4) times in both the length and width directions and the color was measured as an indicator of soiling, recorded as the color change versus control value (delta E) after vacuuming.

Samples with a high value of delta E perform worse than samples with low delta E value.

Hand or Handle: No objective, standardized test method exists to characterize carpet handle. For the handle evaluations, an arbitrary panel of raters, considered to be representative of consumers, is used to evaluate the quality of handle of the carpet materials compared to two extreme examples. The ratings and/or rankings of the samples by the panel are statistically evaluated to determine the handle and distinguishability of the samples.

Embodiment of the present disclosure will be described in greater detail in conjunction with the following, non-limiting examples.

### EXAMPLES

### Example 1

A lubricity-enhanced antisoil treatment sample was made to be applied at 1.2% owf by mixing 33 wt % partially fluorinated urethane polymer in water (N-145, DuPont), 33 wt % silsesquioxane-containing sol, and 33 wt % of a high density polyethylene in water (Fluftone® HDW-35, Apollo). The treatment was labeled as “0.4%” to represent the application rate owf of the lubricity-enhancing agent. Additional treatment samples having different contents of the lubricity-enhancing agents were made by using different amounts of water to replace some or all of the high density polyethylene portion. These lubricity-enhanced antisoil treatment samples were used in Example 2.

### Example 2

A nylon 6,6 carpet sample with 995 denier×2 and 6.0 tpi was obtained by being straight heatset, and tufted in ⅛ gauge machine at about 13 spi with 9/16″ pile height to make a Saxony-style cut pile carpet of ca. 45 oz/sy greige fabric weight. The carpet sample was then treated with a standard amount of styrene maleic anhydride type stain resistant (SR-500, DuPont) at pH=2.1 using a Flex Nip under standard conditions. The stain-resist treated carpet sample was then treated with the lubricity-enhanced antisoil treatment samples from Example 1. The carpet sample after treatment was judged by a panel for the handle. The amount of lubricity-enhancing agent used in the treatment and results of the handle test panel and soil resistance test of the carpet sample is listed in Table 1.

TABLE1
Comparison Results from Example 2

| | | | ASTM soil | |
|---|---|---|---|---|
| | Panel | | ΔE (95% | |
| | Hand | | confidence | Water Repel |
| Sample | Ranking* | Description | intervals) | (1 to 7)** |
| 0% lubricity- | 8 | Somewhat | 11.2-14.2 | 3 |
| enhancing agent | | harsh | | |
| 0.3% lubricity- | | Smooth, | 12.6-15.6 | 4 |
| enhancing agent | | silky | | |
| 0.4% lubricity- | 3.0-4.8 | Smooth, | 13.2-15.6 | 4 |
| enhancing agent | | silky | | |

*Hand ranking is from 1 to 8 wherein 1 is the best with 95% confidence intervals.
**Water repellency ratings were determined according to the Water Drop Test Method described in the INVISTA publication “Global Specifications and Quality Control Tests for Fabrics Treated with Teflon ® Fabric Protector,” which is similar to AATCC test method 193-2004. Water repellency was tested by placing drops of water-alcohol mixtures of varying surface tensions on the fabric, then visually determining the extent of surface wetting. This test provides a rough index of aqueous stain resistance. Generally, the higher the water repellency rating, the better the finished fabric's resistance to staining by water-based substances.

The results indicated that the soil resistance was indistinguishable from samples with and without lubricity-enhancing agent, but the hand of the samples treated with the lubricity-enhancing agent was improved dramatically.

### Example 3

A lubricity-enhanced antisoil treatment sample was made to be applied at 1.2% owf by mixing 40 wt % partially fluorinated urethane polymer in water (N-145, DuPont), 27 wt % silsesquioxane-containing sol, and 33 wt % of a high density polyethylene in water (Fluftone© HDW-35, Apollo). The treatment was labeled as “0.4%” to represent the application rate owf of the lubricity-enhancing agent. Additional treatment samples having different contents of the lubricity-enhancing agents were made by using different amounts of water to replace some or all of the high density polyethylene component. These lubricity-enhanced antisoil treatment samples were used in Example 4.

### Example 4

The carpet sample and treatment using a stain resistant agent were the same as described in Example 2. The stain-resist treated carpet sample was then treated with the lubricity-enhanced antisoil treatment samples from Example 3. The amount of lubricity-enhancing agent used in the treatment and results of the panel handle test and soil resistance test of the carpet sample is listed in Table 2.

TABLE2
Comparison Results from Example 3

| | | | ASTM soil | |
|---|---|---|---|---|
| | Panel | | ΔE (95% | Water |
| | Hand | | confidence | Repel |
| Sample | Rating** | Description | intervals) | (1 to 7) |
| 0% lubricity- | 2.0-4.2 | Somewhat | 10.9-13.3 | 3 |
| enhancing agent | | harsh | | |
| 0.2% lubricity- | 4.2-7.6 | Smooth | 10..9-12.5 | |
| enhancing agent | | | | |
| 0.25% lubricity- | 5.2-7.2 | Smooth, | | |
| enhancing agent | | silky | | |
| 0.3% lubricity- | 4.9-7.5 | Smooth, | 12.2-14.2 | 4 |
| enhancing agent | | silky | | |
| 0.4% lubricity- | 6.6-8.6 | Smooth, | 12.7-14.9 | 3 |
| enhancing agent | | silky | | |

**Hand rating is from 1 to 10 wherein 10 is the best with 95% confidence intervals. The results indicated that the soil resistance was indistinguishable from samples with and without lubricity-enhancing agent, but the handle of the samples treated with the lubricity-enhancing agent was improved dramatically.

### Example 5

A lubricity-enhanced repellent sample is made by mixing 33 wt % partially fluorinated urethane polymer in water (N-145, DuPont), 33 wt % silsesquioxane-containing sol, and 33 wt % a high density polyethylene in water (Fluftone® HDW-35, Apollo). A bed sheeting material is treated to resist staining and soiling using 2% owf of the lubricity-enhanced repellent sample. Control fabric is treated with of a blend of 33 wt % partially fluorinated urethane polymer in water (N-145, DuPont), 33 wt % silsesquioxane-containing sol, and 33 wt % water. The bed sheeting material treated with the lubricity-enhanced repellent sample is judged to have equal or better handle than the control fabric treated without the lubricity-enhancing agent. The soil resistance of the bed sheeting material treated with and without the lubricity-enhancing agent is indistinguishable.

### Example 6

Tables 3 and 4 illustrate some exemplar embodiments of the present disclosure and application rates for each embodiment for carpet products.

TABLE 3
Exemplar Blend Ratios

| | Ratio | Ratio | Ratio | Ratio |
|---|---|---|---|---|
| Sample | % FC | % Si | % Lub | % water |
| A | 45% | 30% | 25% | 0% |
| B | 53% | 35% | 13% | 0% |
| C | 37% | 30% | 33% | 0% |
| D | 49% | 40% | 11% | 0% |
| E | 35% | 35% | 30% | 0% |
| F | 24% | 30% | 25% | 21% |
| G | 33% | 40% | 28% | 0% |
| H | 20% | 30% | 25% | 25% |
| I | 23% | 35% | 25% | 17% |
| J | 27% | 40% | 25% | 8% |
| K | 10% | 30% | 25% | 35% |
| L | 13% | 40% | 33% | 13% |
| M | 43% | 29% | 20% | 8% |
| N | 36% | 27% | 21% | 17% |
| O | 33% | 30% | 25% | 12% |
| P | 33% | 30% | 21% | 16% |
| Q | 33% | 30% | 17% | 20% |
| R | 33% | 27% | 25% | 15% |
| S | 33% | 33% | 25% | 8% |
| T | 25% | 38% | 25% | 13% |
| U | 38% | 30% | 25% | 8% |
| V | 25% | 33% | 25% | 17% |
| W | 56% | 24% | 4% | 16% |

% FC = % fluorochemical (e.g., NRD-626 in this case, but could also be N-145 or other FC supplied as a so-called 5% F fluorochemical; higher-concentration FCs (such as 10% F) would require formula adjustment, generally in the ratio of % F)
% Si = % silsesquioxane-containing sol
% Lub = % lubricity-enhancing agent (HDW-35 in these examples; amount would vary proportionately if using a similar product with different % solids, for example)
% water = % water

TABLE 4
Applied Amounts (on weight of fiber, owf) based on the total applied
amount of the mix (Total % owf).

| Sample | FC % owf | Si % owf | Lub % owf | Wtr % owf | Total % owf |
|---|---|---|---|---|---|
| A | 0.36-0.72% | 0.24-0.48% | 0.20-0.40% | 0.00 | 0.80-1.60% |
| B | 0.42-0.84% | 0.28-0.56% | 0.10-0.20% | 0.00 | 0.80-1.60% |
| C | 0.29-0.59% | 0.24-0.48% | 0.27-0.53% | 0.00 | 0.80-1.60% |
| D | 0.39-0.78% | 0.32-0.64% | 0.09-0.17% | 0.00 | 0.80-1.60% |
| E | 0.28-0.56% | 0.28-0.56% | 0.24-0.48% | 0.00 | 0.80-1.60% |
| F | 0.19-0.39% | 0.24-0.48% | 0.20-0.40% | 0.17-0.33% | 0.80-1.60% |
| G | 0.26-0.52% | 0.32-0.64% | 0.22-0.44% | 0.00 | 0.80-1.60% |
| H | 0.16-0.32% | 0.24-0.48% | 0.20-0.40% | 0.20-0.40% | 0.80-1.60% |
| I | 0.19-0.37% | 0.28-0.56% | 0.20-0.40% | 0.13-0.27% | 0.80-1.60% |
| J | 0.21-0.43% | 0.32-0.64% | 0.20-0.40% | 0.13-0.20% | 0.80-1.60% |
| K | 0.08-0.16% | 0.24-0.48% | 0.20-0.40% | 0.28-0.56% | 0.80-1.60% |
| L | 0.11-0.21% | 0.32-0.64% | 0.27-0.53% | 0.11-0.21% | 0.80-1.60% |
| M | 0.36-0.72% | 0.24-0.48% | 0.17-0.33% | 0.07-0.13% | 0.83-1.66% |
| N | 0.29-0.57% | 0.21-0.43% | 0.17-0.33% | 0.13-0.27% | 0.80-1.60% |
| O | 0.27-0.53% | 0.24-0.58% | 0.20-0.40% | 0.09-0.19% | 0.80-1.60% |
| P | 0.27-0.53% | 0.24-0.48% | 0.17-0.33% | 0.13-0.25% | 0.80-1.60% |
| Q | 0.27-0.53% | 0.24-0.48% | 0.13-0.27% | 0.16-0.32% | 0.80-1.60% |
| R | 0.27-0.53% | 0.21-0.43% | 0.20-0.40% | 0.12-0.24% | 0.80-1.60% |
| S | 0.27-0.53% | 0.27-0.53% | 0.20.0.40% | 0.07-0.13% | 0.80-1.60% |
| T | 0.20-0.40% | 0.30-0.60% | 0.20-0.40% | 0.10-0.20% | 0.80-1.60% |
| U | 0.30-0.60% | 0.24-0.48% | 0.20-0.40% | 0.06-0.12% | 0.80-1.60% |
| V | 0.20-0.40% | 0.27-0.53% | 0.20-0.40% | 0.13-0.27% | 0.80-1.60% |
| W | 0.47-0.93% | 0.20-0.40% | 0.03-0.07% | 0.13-0.27% | 0.83-1.66% |

FC % owf = % owf (on weight of fiber) of the fluorochemical material (NRD-626)
Si % owf = % owf (on weight of fiber) of the silsesquioxane-containing sol
Lub % owf = % owf (on weight of fiber) of the lubricity-enhancing agent (HDW-35)
Wtr % owf = % owf (on weight of fiber) of the water

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include ±1%, ±2%, ±3%, ±4%, ±5%, ±6%, ±7%, ±8%, ±9%, or ±10%, or more of the numerical value(s) being modified. In addition, the phrase “about ‘x’ to ‘y’ includes “about ‘x’ to about ‘y’”.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

We claim the following:

1. A soil repellent composition imparting soil resistance on a fibrous substrate comprising a water-based mixture of:
(a) a fluorochemical,
(b) a silsesquioxane-containing sol, and
(c) a lubricity-enhancing agent.

2. The composition according to claim 1, wherein the fluorochemical is selected from: a fluorocarbonylimino biuret, a fluoroester, a fluoroester carbamate, a fluorourethane, a fluoroacrylate, a fluoropolymer, or a mixture thereof.

3. The composition according to claim 1, wherein the silsesquioxane-containing sol comprises a polymer of the formula RSiO_{3/2}, where R is a substituted or unsubstituted hydrocarbon up to 7 carbon atoms.

4. The composition according to claim 1, wherein the silsesquioxane-containing sol comprises at least one of co-polymers of the formula RSiO_{3/2}, R′₂SiO, or R″₃SiO_{1/2} where R, R′, and R″ are each independently substituted or unsubstituted hydrocarbons up to 7 carbon atoms, and mixtures thereof.

5. The composition according to claim 1, wherein the lubricity-enhancing agent comprises: a lubricity-enhancing agent selected from: a cationic lubricity-enhancing agent, a nonionic lubricity-enhancing agent, an anionic lubricity-enhancing agent, an amphoteric lubricity-enhancing agent, or a combination thereof.

6. The composition, according to claim 1, wherein the lubricity-enhancing agent is a high density polyethylene.

7. The composition according to claim 6, wherein the high density polyethylene is partially oxidized.

8. The composition according to claim 1, wherein the applied solids content of the composition is in the range of from about 0.01 wt % to 1.0 wt % based on the total weight of the fibrous substrate.

9. The composition according to claim 1, wherein the applied solids content of the composition is in the range of from about 0.02 to 0.5 wt % based on the total weight of the fibrous substrate.

10. The composition according to claim 1, wherein the applied solids content of the composition is in the range of from about 0.05 to 0.35 wt % based on the total weight of the fibrous substrate.

11. The composition, according to claim 1, further comprising a stain resistance agent.

12. The composition according to claim 11, wherein the stain resistant agent is selected from: a sulfonated phenol-aldehyde condensation product, a sulfonated naphthol-aldehyde condensation product, a polymethacrylic acid polymer, an acrylic acid polymer, a copolymers of acrylic acid or methacrylic acid with ethylenically unsaturated comonomers, a hydrolyzed maleic anhydride copolymer with an ethylenically unsaturated comonomer, or a mixture thereof.

13. The composition according to claim 1, wherein the lubricity-enhancing agent component of the composition is about 0.01 to 0.2 wt % of dried solids based on the total weight of the fibrous substrate.

14. A method for imparting resistance to soiling on a fibrous substrate, the method comprising contacting the fibrous substrate with a soil repellent composition followed by drying, the soil repellent composition comprising a water-based mixture of:
(a) a fluorochemical,
(b) a silsesquioxane-containing sol, and
(c) a lubricity-enhancing agent.

15. The method of claim 14, wherein the fluorochemical is selected from: a fluorocarbonyllimino biuret, a fluoroester, a fluoroester carbamate, a fluorourethane, a fluoroacrylate, a fluoropolymer, or a mixture thereof.

16. The method of claim 14, wherein the silsesquioxane-containing sol comprises a polymer of the formula RSiO_{3/2}, where R is a substituted or unsubstituted hydrocarbons up to 7 carbon atoms.

17. The method of claim 14, wherein the silsesquioxane-containing sol comprises at least one of co-polymers of the formula RSiO_{3/2}, R′₂SiO, or R″₃SiO_{1/2} where R, R′, and R″ are each independently substituted or unsubstituted hydrocarbons up to 7 carbon atoms, and mixtures thereof.

18. The method of claim 14, wherein said lubricity-enhancing agent comprises a high density polyethylene.

19. The method of claim 18, wherein the high density polyethylene is partially oxidized.

20. A fibrous substrate to which a soil repellent composition has been applied and dried, the soil repellent composition comprising a water-based mixture of:
(a) a fluorochemical,
(b) a silsesquioxane-containing sol, and
(c) a lubricity-enhancing agent.

21. The fibrous substrate of claim 20, wherein the fluorochemical is selected from: a fluorocarbonyllimino biuret, a fluoroester, a fluoroester carbamate, a fluorourethane, a fluoroacrylate, a fluoropolymer, or a mixture thereof.

22. The fibrous substrate of claim 20, wherein the silsesquioxane-containing sol comprises a polymer of the formula RSiO_{3/2} where R is a substituted or unsubstituted hydrocarbons up to 7 carbon atoms.

23. The fibrous substrate of claim 20, wherein the silsesquioxane-containing sol comprises at least one of co-polymers of the formula RSiO_{3/2}, R′₂SiO, or R″₃SiO_{1/2} where R, R′, and R″ are each independently substituted or unsubstituted hydrocarbons up to 7 carbon atoms, and mixtures thereof.

24. The fibrous substrate of claim 20, wherein the lubricity-enhancing agent comprises a high density polyethylene.

25. The fibrous substrate of claim 24, wherein the high density polyethylene is partially oxidized.

26. A method for imparting resistance to soiling on a fibrous substrate, the method comprising the sequential steps of,
(a) mixing a fluorochemical and a silsesquioxane-containing sol to form a blend;
(b) treating the fibrous substrate with the blend;
(c) applying a lubricity-enhancing agent to the treated fibrous substrate; and
(d) drying.

27. A method for imparting resistance to soiling on a fibrous substrate, the method comprising the sequential steps of,
(a) mixing a fluorochemical and a lubricity-enhancing agent to form a blend;
(b) treating the fibrous substrate with the blend;
(c) applying a silsesquioxane-containing sol to the treated fibrous substrate; and
(d) drying.

28. A method for imparting resistance to soiling on a fibrous substrate, the method comprising the sequential steps of,
(a) treating the fibrous substrate with a fluorochemical,
(b) mixing a silsesquioxane-containing sol and a lubricity-enhancing agent to form a blend;
(c) applying the blend to the fibrous substrate from step (a); and
(d) drying.

29. A method for imparting resistance to soiling on a fibrous substrate, the method comprising the sequential steps of,
(a) contacting the fibrous substrate with a fluorochemical;
(b) treating the fibrous substrate from step (a) with a silsesquioxane-containing sol;
(c) applying a lubricity-enhancing agent to the fibrous substrate from step (b); and
(d) drying.
